(19) United States
(12) Patent Application Publication
(10) Pub. No.: US 2017/0265221 A1
(43) Pub. Date: Sep. 14, 2017

(54) DIRECTIONAL CHANNEL ACCESS TECHNIQUES FOR WIRELESS COMMUNICATION NETWORKS

(71) Applicants: Ou Yang, Santa Clara, CA (US); Carlos Cordeiro, Portland, OR (US); Solomon Trainin, Haifa (IL); Laurent Cariou, Portland, OR (US)

(72) Inventors: Ou Yang, Santa Clara, CA (US); Carlos Cordeiro, Portland, OR (US); Solomon Trainin, Haifa (IL); Laurent Cariou, Portland, OR (US)

(21) Appl. No.: 15/201,379

(22) Filed: Jul. 1, 2016

Related U.S. Application Data
(60) Provisional application No. 62/305,463, filed on Mar. 8, 2016.

(51) Int. Cl. H04W 74/00; H04B 7/06; H04B 7/04; H04W 48/02

(52) U.S. Cl. CPC H04W 74/002; H04W 48/02; H04B 7/0617; H04B 7/0413

(57) ABSTRACT

Directional channel access techniques for wireless communication networks are described. According to various such techniques, a directional channel access mechanism may be implemented in order to enable improved spatial reuse in a wireless network. In some embodiments, according to the directional channel access mechanism, a wireless communication device may be able to perform multiple concurrent channel accesses in different respective directions. In various embodiments, a wireless communication device utilizing the directional channel access mechanism may transmit in multiple different directions at the same time. In some embodiments, a wireless communication device utilizing the directional channel access mechanism may receive from multiple different directions at the same time. In various embodiments, a wireless communication device utilizing the directional channel access mechanism may transmit in one or more directions and receive from one or more other directions at the same time. Other embodiments are described and claimed.

### RELATED CASE

This application claims priority to U.S. Provisional Patent Application No. 62/305,463, filed Mar. 8, 2016, the entirety of which is hereby incorporated by reference.

### TECHNICAL FIELD

Embodiments described herein generally relate to wireless communications between devices in wireless networks.

### BACKGROUND

In some types of wireless communication networks, wireless communication devices may communicate with each other using directional transmission and/or reception techniques. In performing directional transmission, a transmitting device may transmit data in a certain direction, towards an intended recipient of that data, and devices that are not located in that direction may be unlikely to receive the transmission. In performing directional reception, a receiving device may monitor a particular direction for incoming transmissions from a transmitting device, and may be unlikely to receive transmissions from devices that are not located in that direction. Beamforming techniques may be used in order to determine the directions used for such directional transmissions and/or receptions.

### BRIEF DESCRIPTION OF THE DRAWINGS

FIG. 1 illustrates an embodiment of a first operating environment.

FIG. 2 illustrates an embodiment of a first channel access scheme.

FIG. 3 illustrates an embodiment of a second operating environment.

FIG. 4 illustrates an embodiment of a second channel access scheme.

FIG. 5 illustrates an embodiment of a logic flow.

FIG. 6 illustrates an embodiment of a first storage medium.

FIG. 7 illustrates an embodiment of a second storage medium.

FIG. 8 illustrates an embodiment of a device.

FIG. 9 illustrates an embodiment of a wireless network.

### DETAILED DESCRIPTION

Various embodiments may be generally directed to directional channel access techniques for wireless communication networks. According to various such techniques, a directional channel access mechanism may be implemented in order to enable improved spatial reuse in a wireless network. In some embodiments, according to the directional channel access mechanism, a wireless communication device may be able to perform multiple concurrent channel accesses in different respective directions. In various embodiments, a wireless communication device utilizing the directional channel access mechanism may transmit in multiple different directions at the same time. In some embodiments, a wireless communication device utilizing the directional channel access mechanism may receive from multiple different directions at the same time. In various embodiments, a wireless communication device utilizing the directional channel access mechanism may transmit in one or more directions and receive from one or more other directions at the same time. Other embodiments are described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrases “in one embodiment,” “in some embodiments,” and “in various embodiments” in various places in the specification are not necessarily all referring to the same embodiment.

Various embodiments herein are generally directed to wireless communications systems. Some embodiments are particularly directed to wireless communications over 60 GHz frequencies. Various such embodiments may involve wireless communications performed according to one or more standards for 60 GHz wireless communications. For example, some embodiments may involve wireless communications performed according to one or more Wireless Gigabit Alliance (“WiGig”)/Institute of Electrical and Electronics Engineers (IEEE) 802.11ad standards, such as IEEE 802.11ad-2012, including their predecessors, revisions, progeny, and/or variants. Various embodiments may involve wireless communications performed according to one or more “next-generation”60 GHz (“NG60”) wireless local area network (WLAN) communications standards, such as the IEEE 802.11ay standard that is currently under development. Some embodiments may involve wireless communications performed according to one or more millimeter-wave (mmWave) wireless communication standards. It is worthy of note that the term “60 GHz,” as it is employed in reference to various wireless communications devices, wireless communications frequencies, and wireless communications standards herein, is not intended to specifically denote a frequency of exactly 60 GHz, but rather is intended to generally refer to frequencies in, or near, the 57 GHz to 64 GHz frequency band or any nearby unlicensed band. The embodiments are not limited in this context.

Various embodiments may additionally or alternatively involve wireless communications according to one or more other wireless communication standards. Some embodiments may involve wireless communications performed according to one or more broadband wireless communication standards. For example, various embodiments may involve wireless communications performed according to one or more 3rd Generation Partnership Project (3GPP), 3GPP Long Term Evolution (LTE), and/or 3GPP LTE-Advanced (LTE-A) technologies and/or standards, including their predecessors, revisions, progeny, and/or variants. Additional examples of broadband wireless communication technologies/standards that may be utilized in some embodiments may include—without limitation—Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS), IEEE 802.16 wireless broadband standards such as IEEE 802.16m and/or IEEE 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1×RTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their predecessors, revisions, progeny, and/or variants.

Further examples of wireless communications technologies and/or standards that may be used in various embodiments may include—without limitation—other IEEE wireless communication standards such as the IEEE 802.11, IEEE 802.11a, IEEE 802.11b, IEEE 802.11g, IEEE 802.11n, IEEE 802.11u, IEEE 802.11ac, IEEE 802.11af, and/or IEEE 802.11ah standards, High-Efficiency Wi-Fi standards developed by the IEEE 802.11 High Efficiency WLAN (HEW) Study Group and/or IEEE 802.11 Task Group (TG) ax, Wi-Fi Alliance (WFA) wireless communication standards such as Wi-Fi, Wi-Fi Direct, Wi-Fi Direct Services, WiGig Display Extension (WDE), WiGig Bus Extension (WBE), WiGig Serial Extension (WSE) standards and/or standards developed by the WFA Neighbor Awareness Networking (NAN) Task Group, machine-type communications (MTC) standards such as those embodied in 3GPP Technical Report (TR) 23.887, 3GPP Technical Specification (TS) 22.368, and/or 3GPP TS 23.682, and/or near-field communication (NFC) standards such as standards developed by the NFC Forum, including any predecessors, revisions, progeny, and/or variants of any of the above. The embodiments are not limited to these examples.

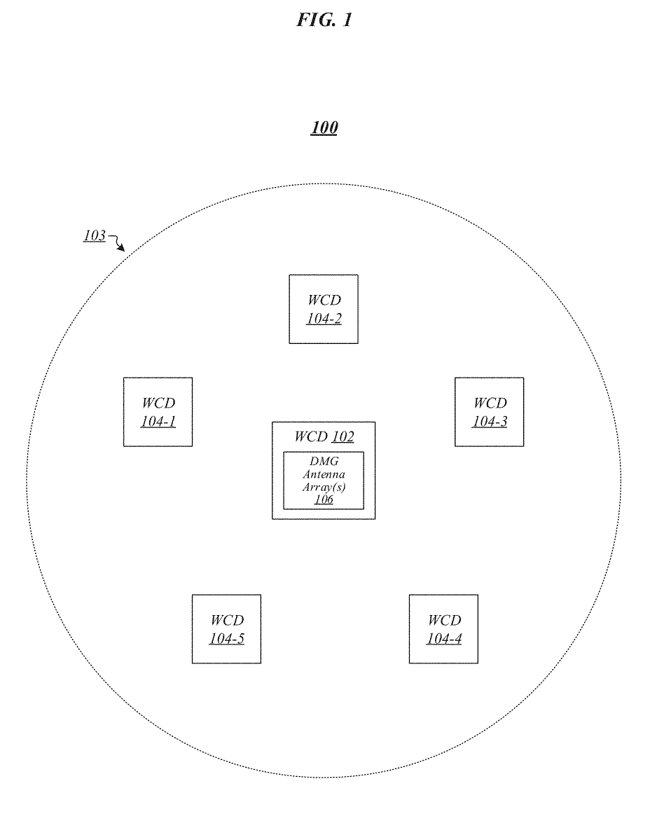

FIG. 1 illustrates an example of an operating environment 100 that may be representative of various embodiments. In operating environment 100, a wireless communication device (WCD) 102 may generally be operative to wirelessly communicate with one or more other devices in a wireless network 103. In some embodiments, the one or more other devices may include one or more of the wireless communication devices 104-1 to 104-5 depicted in FIG. 1. In various embodiments, wireless network 103 may comprise a wireless network that utilizes wireless channel frequencies of the 60 GHz band. In some embodiments, wireless communication devices within wireless network 103 may communicate with each other according to one or more standards for 60 GHz wireless communications. For example, in various embodiments, devices within wireless network 103 may communicate with each other according to one or more protocols and/or procedures defined in IEEE 802.11ad-2012, and/or its predecessors, revisions, progeny, and/or variants. In some embodiments, wireless communication devices 102, 104-1, 104-2, 104-3, 104-4, and 104-5 may comprise 60 GHz-capable stations (STAs) such as Directional Multi-Gigabit (DMG) stations (STAs). In various embodiments, some or all of the wireless communication devices within wireless network 103 may communicate with each other according to one or more protocols and/or procedures that may be defined in the IEEE 802.11ay standard that is currently under development. In some embodiments, wireless communication device 102 may operate as a personal basic service set (PBSS) control point/access point (PCP/AP). The embodiments are not limited in this context.

In various embodiments, wireless communication device 102 may be configured to perform directional transmission and/or directional reception in conjunction with wirelessly communicating in wireless network 103. In some embodiments, wireless communication device 102 may be configured to perform such directional transmission and/or reception using a set of multiple DMG antenna arrays 106. In various embodiments, each of the multiple DMG antenna arrays 106 may be used for transmission and/or reception in a particular respective direction or range of directions. In some embodiments, wireless communication device 102 may be configured such that it performs any given directional transmission towards one or more defined transmit sectors. In various embodiments, wireless communication device 102 may be configured such that it performs any given directional reception from one or more defined receive sectors.

In some embodiments, wireless communication device 102 may perform transmissions in wireless network 103 in accordance with a channel access mechanism. In various embodiments, the channel access mechanism may generally define a medium access control (MAC)-layer scheme for prioritizing between MAC service data units (MSDUs) in conjunction with engaging in wireless transmission in wireless network 103. In some embodiments, the channel access mechanism may define a scheme according to which a given MSDU may be mapped to one of multiple defined access categories (ACs). In various such embodiments, according to the defined scheme, the given MSDU may be mapped to one of the multiple defined ACs based on a user priority (UP) value associated with the given MSDU. In some embodiments, the UP may be assigned to the given MSDU in layers above the MAC layer.

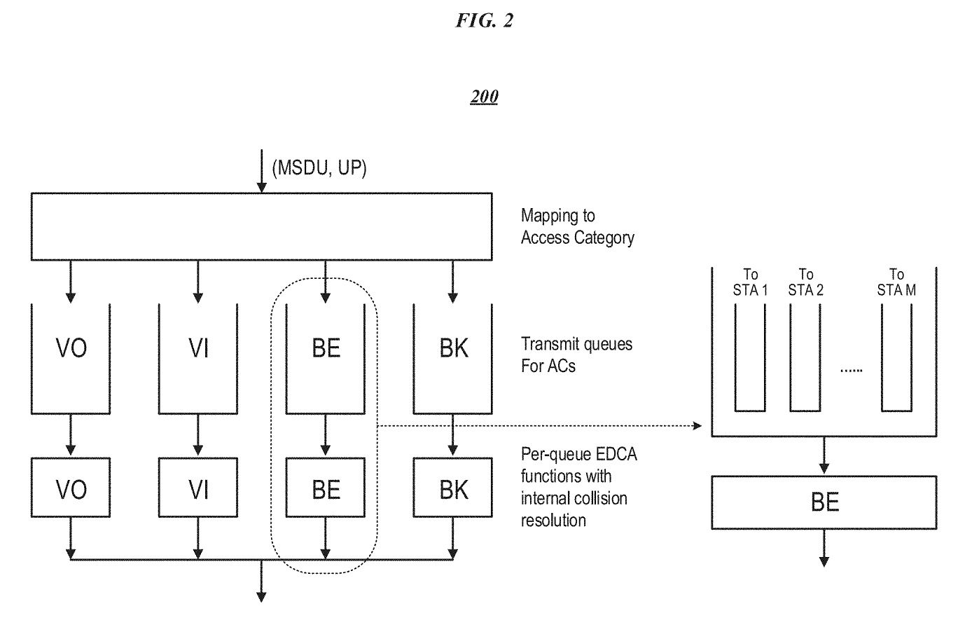

FIG. 2 illustrates an example of a channel access mechanism 200 that may be representative of a channel access mechanism usable by wireless communication device 102 to prioritize between MSDUs in conjunction with engaging in wireless transmission in operating environment 100 of FIG. 1. According to various embodiments, channel access mechanism 200 may be representative of an enhanced distributed channel access (EDCA) mechanism, such as an EDCA mechanism defined in IEEE 802.11ad-2012.

According to channel access mechanism 200, when an MSDU arrives from an upper layer to the MAC layer, the MSDU may first be mapped to one of four defined access categories (ACs) based on its user priority (UP). These four ACs include, in descending priority order, a voice (VO) access category, a video (VI) access category, a best effort (BE) access category, and a background (BK) access category. The MSDU is then routed to a transmit queue corresponding to the AC to which the MSDU has been mapped. Each such transmit queue may have a corresponding EDCA function (EDCAF), which may define a backoff window size, arbitration interframe space (AIFS), and transmission opportunity (TXOP) length for all MSDUs in the corresponding AC. An internal collision resolution scheme may resolve conflicts between EDCAFs of different queues, and may, for example, allow an MSDU from a higher-priority queue to access the channel and defer an MSDU from a lower-priority queue when the two queues have backoff timers expire at the substantially the same time. With respect to each transmit queue, in order to enable MSDU aggregation, the contained MSDUs are organized into multiple sub-queues, each of which may correspond to a different respective destination STA. Among the various sub-queues in the various queues of channel access mechanism 200, a given sub-queue may be identified by the AC and destination STA to which it corresponds.

Returning to FIG. 1, in operating environment 100, the wireless communications between devices in wireless network 103 may generally be directional in nature, which may enhance the potential for spatial reuse in wireless network 103. However, conventional channel access mechanisms may feature characteristics that may tend to interfere with the ability of devices in wireless network 103 to capitalize on the potential for spatial reuse. For example, according to the IEEE 802.11ad ECDA mechanism, a station is not able to transmit if it senses a busy channel, regardless of the direction from which the sensed signal is received—as long as the wireless medium in one direction is busy, transmission cannot be performed in any direction. Furthermore, the IEEE 802.11ad ECDA mechanism only supports transmission or reception in one direction at a time. Due to such characteristics, configuring the devices in wireless network 103 to utilize the IEEE 802.11ad ECDA mechanism may inhibit their ability to take advantage of the enhanced spatial reuse potential associated with their directional communication capabilities.

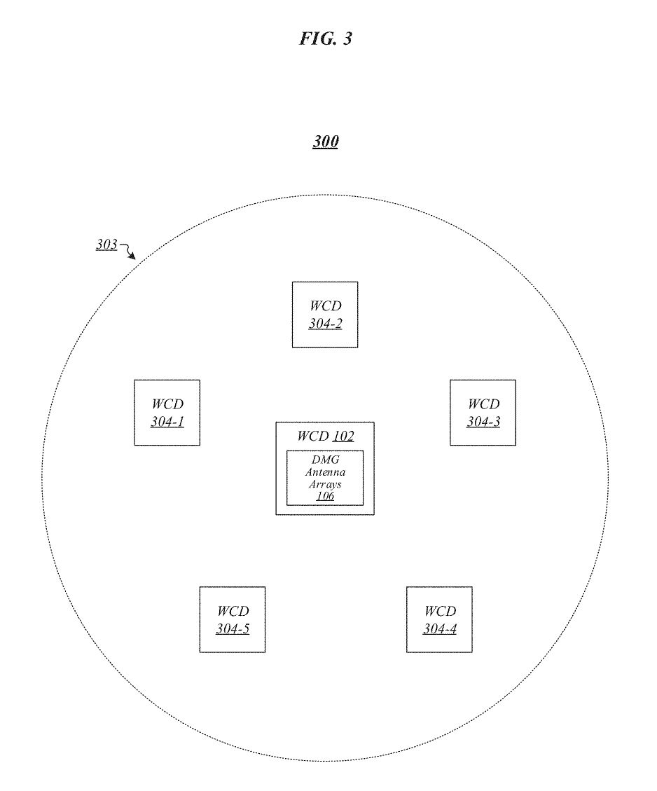

FIG. 3 illustrates an example of an operating environment 300 that may be representative of some embodiments. In operating environment 300, a directional channel access mechanism may be implemented in order to enable improved spatial reuse in a wireless network 303. In this example, wireless communication device 102 may be configured to utilize the directional channel access mechanism in conjunction with wirelessly communicating with one or more other devices in wireless network 303. In various embodiments, the one or more other devices may include one or more of the wireless communication devices 304-1 to 304-5 depicted in FIG. 3. In some embodiments, the one or more other devices may also be configured to utilize the directional channel access mechanism. In various embodiments, multiple-input multiple-output (MIMO) beamforming in wireless network 103 may be accomplished using radio frequency (RF) beamforming and digital beamforming. In some embodiments, in performing a given MIMO transmission, wireless communication device 102 may be permitted to use all of its DMG antenna arrays 106 or a subset of its DMG antenna arrays 106. The embodiments are not limited in this context.

In various embodiments, according to the directional channel access mechanism, wireless communication device 102 may be able to perform multiple concurrent channel accesses in different respective directions. In some embodiments, the various possible directions in which wireless communication device 102 may perform channel accesses may correspond to the respective coverages of its various DMG antenna arrays 106. In some embodiments, according to the directional channel access mechanism, wireless communication device 102 may use multiple DMG antenna arrays 106 to simultaneously/concurrently perform multiple respective clear channel assessments (CCAs). In various embodiments, the DMG antenna arrays 106 may operate in a quasi-omnidirectional mode in conjunction with performing the multiple respective CCAs. In some embodiments, wireless communication device 102 may use the CCAs of the various DMG antenna arrays 106 to detect preambles and receive packets via those DMG antenna arrays 106.

In various embodiments, when a CCA of a given DMG antenna array 106 indicates a busy status, transmission in a direction corresponding to that DMG antenna array 106 may be deferred. In some embodiments, when a CCA of a given DMG antenna array 106 indicates a clear status, a backoff timer associated with a direction corresponding to that DMG antenna array 106 may be decreased. In various embodiments, according to the directional channel access mechanism, when a CCA of a given DMG antenna array 106 indicates a clear status and the associated backoff timer has reached zero, wireless communication device 102 may be able to transmit from that DMG antenna array 106 regardless of whether CCAs of other DMG antenna arrays 106 have indicated busy statuses. According to the directional channel access mechanism in some embodiments, wireless communication device 102 may be able to transmit in multiple different directions at the same time. According to the directional channel access mechanism in various embodiments, wireless communication device 102 may be able to receive from multiple different directions at the same time. According to the directional channel access mechanism in some embodiments, wireless communication device 102 may be able to transmit in one or more directions and receive from one or more other directions at the same time. The embodiments are not limited in this context.

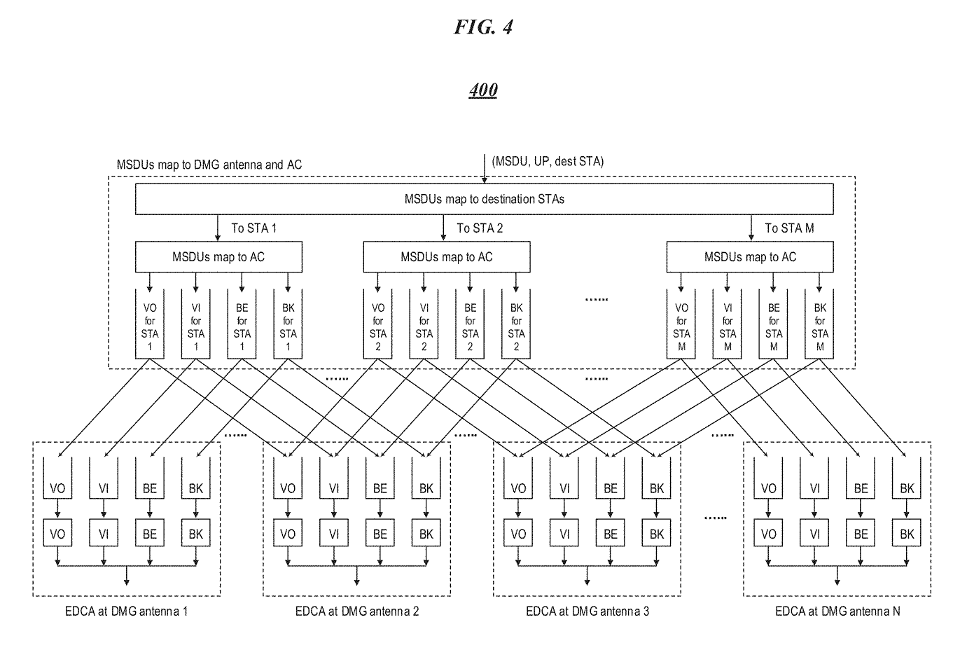

FIG. 4 illustrates a channel access mechanism 400 that may be representative of a directional channel access mechanism usable by wireless communication device 102 to prioritize between MSDUs in conjunction with engaging in wireless transmission in operating environment 300 of FIG. 3. Channel access mechanism 400 may be representative of a directional channel access mechanism that may be implemented by devices in wireless network 303 of FIG. 3 in order to achieve improved spatial utilization in wireless network 303. According to various embodiments, channel access mechanism 400 may generally be representative of a modified version of an EDCA, such as an IEEE 802.11ad EDCA. The embodiments are not limited in this context.

According to channel access mechanism 400, MSDUs arriving from an upper layer to the MAC layer may first be grouped based on the respective devices to which they are directed, which may be referred to as the “destination STAs” of the MSDUs. Each of the MSDUs of a given destination STA may be mapped to one of the four defined ACs (VO, VI, BE, and BK), and routed to a corresponding transmit queue. Thus, four transmit queues may be defined for each destination STA, and each such transmit queue may be identified by the AC and destination STA to which it corresponds and may be referred to as a destination-and-AC-specific (DACS) transmit queue. Four transmit queues may also be defined for each DMG antenna array of the transmitting device, each of which may correspond to one of the four defined ACs, may have a corresponding EDCAF, and may be referred to as an antenna-and-AC-specific (AACS) transmit queue. An internal collision resolution scheme may resolve conflicts between EDCAFs of different AACS transmit queues. With respect to each AACS transmit queue of each DMG antenna array, the contained MSDUs may be organized into multiple sub-queues, each of which may correspond to a different respective destination STA and may be referred to as a destination-specific sub-queue. For example, a BE AACS transmit queue for DMG antenna array 2 may be organized into multiple destination-specific sub-queues that include a sub-queue for destination STA 1 and a sub-queue for destination STA 2.

In some embodiments, mappings between particular destination STAs and particular DMG antenna arrays may be determined based on beamforming results. In various embodiments, a destination STA may be mapped to one or more DMG antenna arrays, depending on whether transmissions to the destination STA are single-input single-output (SISO) or MIMO. In some embodiments, after beamforming, a STA may have knowledge of a best TX sector for each beamformed destination STA. In various embodiments, a destination STA expecting SISO transmissions may be mapped to a DMG antenna array that has the best TX sector for that destination STA. In some embodiments, a destination STA expecting MIMO transmissions may be mapped to multiple DMG antenna arrays based on RF beamforming results. In various embodiments, the mapping between destination STAs and DMG antenna arrays may be updated accordingly each time beamforming is performed.

In some embodiments, when a destination STA is mapped to a DMG antenna array, the DACS transmit queues of the destination STA may be mapped to the AACS transmit queues of the DMG antenna array according to their respective associated ACs. In such embodiments, the VO, VI, BE, and BK DACS transmit queues of the destination STA may be mapped to the VO, VI, BE, and BK AACS transmit queues, respectively, of the DMG antenna array. In some embodiments, the DACS transmit queues of the destination STA may more particularly be mapped to destination-specific sub-queues within the AACS transmit queues of the DMG antenna array, where each such destination-specific sub-queue comprises a sub-queue associated with the destination STA. In various embodiments, to avoid excessive data movement between queues of different DMA antenna arrays due to re-beamforming, the transmitting STA may store only one copy of each MSDU and the mappings between destination STAs and DMG antennas may be observed without MSDU moving or copying. In some embodiments, mapping information may be used to locate an MSDU for transmission when a AACS transmit queue of a given DMG antenna has its backoff timer reach zero. In various embodiments, a transmitting STA utilizing channel access mechanism 400 may use a legacy MSDU selection procedure in conjunction with selecting an MSDU for transmission during a current TXOP.

Returning to FIG. 3, in some embodiments, wireless communication device 102 may be configured to utilize channel access mechanism 400 in conjunction with wirelessly communicating with one or more other devices in wireless network 303. In various embodiments, all of the DMG antenna arrays 106 of wireless communication device 102 may perform CCAs simultaneously. In some embodiments, if a DMG antenna array 106 has CCA clear, it may decrease the backoff timers of all of its AACS transmit queues. In various embodiments, if a DMG antenna has CCA busy, it may suspend the backoff timers of all of its AACS transmit queues.

In some embodiments, if only one DMG antenna array 106 has a backoff timer that has reached zero, and a next physical layer convergence protocol (PLCP) protocol data unit (PPDU) to be transmitted is designated for SISO transmission, wireless communication device 102 may transmit the PPDU using that DMG antenna array 106. In various embodiments, if only one DMG antenna array 106 has a backoff timer reach zero, and a next PPDU to be transmitted is designated for MIMO transmission, wireless communication device 102 may transmit the PPDU using all of the DMG antenna arrays 106 having clear CCAs, or using a subset of the DMG antenna arrays 106 having clear CCAs. In some embodiments, wireless communication device 102 may be provided the option of foregoing the transmission opportunity by generating new backoff timers or holding the transmission with backoff timer 0 for all AACS transmit queues of the DMG antenna, and waiting for more DMG antennas to become available/usable at a subsequent point in time. In various embodiments, wireless communication device 102 may be operative to notify the destination device of which DMG antenna arrays 106 are used for the MIMO transmission. In some embodiments, if only one DMG antenna array 106 has a clear CCA, MIMO transmission may be achieved using differing antenna array polarizations if supported by the system, or SISO transmission may be performed instead. Alternatively, new backoff timers may be generated for all AACS transmit queues of the DMG antenna array 106 having the clear CCA. The embodiments are not limited in this context.

In various embodiments, multiple DMG antenna arrays 106 may have backoff timers that have reached zero. In some such embodiments, if the PPDUs on the available DMG antenna arrays 106 are for SISO transmissions, wireless communication device 102 may have the option to either (1) pick one PPDU to transmit using the corresponding DMG antenna array 106 and defer the PPDUs on the other available DMG antenna arrays 106, or (2) perform multiple SISO transmissions at the same time if the corresponding DMG antenna arrays are well isolated, and defer the PPDUs, if any, that are not transmitted due to interference at the corresponding DMG antenna arrays.

In various embodiments, if multiple DMG antenna arrays 106 have backoff timers that have reached zero and the PPDUs on the available DMG antenna arrays 106 are for SU-MIMO transmissions, wireless communication device 102 may have the option to (1) pick one PPDU to transmit by using all or a subset of the available DMG antenna arrays 106 with clear CCAs, and defer the other PPDUs, or (2) give up the transmission opportunity by generating new backoff timers or holding the transmission with backoff timer 0 for all AACS transmit queues at the available DMG antenna arrays 106, and waiting for more DMG antenna arrays to become available at a subsequent time, or (3) perform multiple SU-MIMO transmissions at the same time if the corresponding DMG antenna arrays 106 are well isolated, and defer the PPDUs that are not transmitted due to interference at the corresponding DMG antenna arrays. In some such embodiments, if SU-MIMO transmission is performed, wireless communication device 102 may need to inform the destination device of the DMG antenna arrays 106 that are used for transmission.

In various embodiments, if multiple DMG antenna arrays 106 have backoff timers that have reached zero and the PPDUs on the available DMG antenna arrays 106 are for MU-MIMO transmissions, wireless communication device 102 may have the option of either (1) picking one MU-MIMO group to serve using all or a subset of the available DMG antenna arrays 106 with clear CCAs, and deferring the transmissions for MU-MIMO groups that are not served, or (2) giving up the transmission opportunity by generating new backoff timers or holding the transmission with backoff timer 0 for all AACS transmit queues at the available DMG antenna arrays 106, and waiting for more DMG antenna arrays 106 to become available at a subsequent time. In some such embodiments, if MU-MIMO transmission is performed, wireless communication device 102 may need to inform the destination device of the DMG antenna arrays 106 that are used for transmission.

In various embodiments, if multiple DMG antenna arrays 106 have backoff timers that have reached zero and some PPDUs are for SISO transmission while others are for MIMO transmission, wireless communication device 102 may have the option of either (1) performing single or multiple SISO transmissions, and deferring the PPDUs that are not transmitted, or (2) performing MIMO transmissions, and deferring the PPDUs that are not transmitted. In some embodiments, when multiple SISO or MIMO transmissions are performed simultaneously, the results may be best when the utilized DMG antenna arrays 106 are well isolated. The embodiments are not limited in this context.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

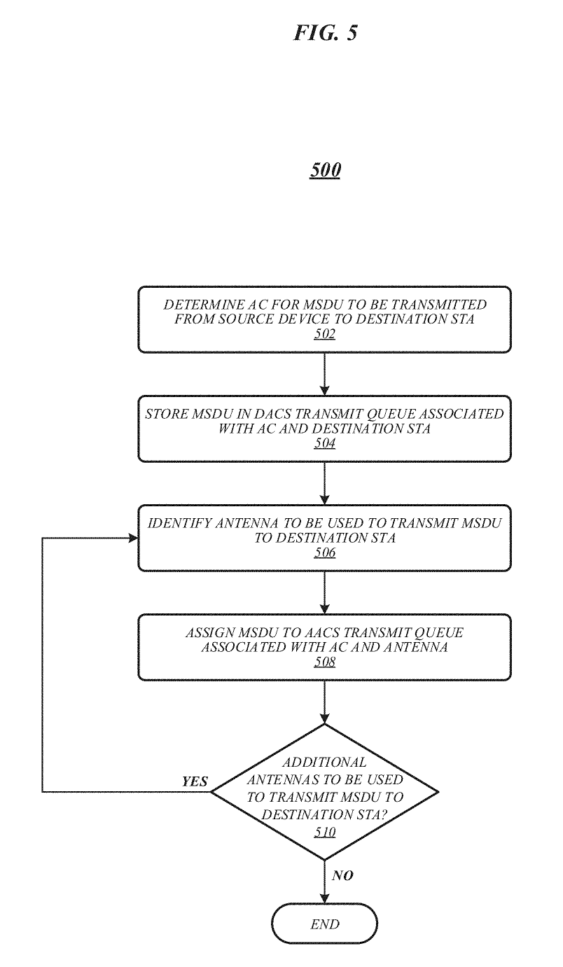

FIG. 5 illustrates an example of a logic flow 500 that may be representative of the implementation of one or more of the disclosed directional channel access techniques according to various embodiments. For example, logic flow 500 may be representative of operations that may be performed in some embodiments by wireless communication device 102 in conjunction with the implementation of one or more of the disclosed directional channel access techniques. As shown in FIG. 5, an AC may be determined at 502 for an MSDU to be transmitted from a source device to a destination STA. For example, wireless communication device 102 may determine an AC for an MSDU to be transmitted to wireless communication device 304-1, which may comprise a STA. At 504, the MSDU may be stored in a DACS transmit queue associated with the AC and the destination STA. For example, after determining an AC for an MSDU to be transmitted to wireless communication device 304-1, wireless communication device 102 may store the MSDU in a DACS transmit queue associated with that AC and with wireless communication device 304-1.

At 506, an antenna to be used to transmit the MSDU to the destination STA may be identified. For example, wireless communication device 102 may identify a DMG antenna array to be used to transmit the MSDU to wireless communication device 304-1. At 508, the MSDU may be assigned to an AACS transmit queue associated with the AC and the antenna identified at 506. For example, after identifying a DMG antenna array at 506, wireless communication device 102 may assign the MSDU to an AACS transmit queue associated with that DMG antenna array and with the AC determined at 502. At 510, it may be determined whether any additional antennas are also to be used to transmit the MSDU to the destination STA. If it is determined at 510 that no additional antennas are to be used to transmit the MSDU to the destination STA, the logic flow may end. If it is determined at 510 that one or more additional antennas are to be used to transmit the MSDU to the destination STA, flow may return to 506, where a next antenna may be identified. The embodiments are not limited in this context.

Various embodiments of the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc. The embodiments are not limited in this context.

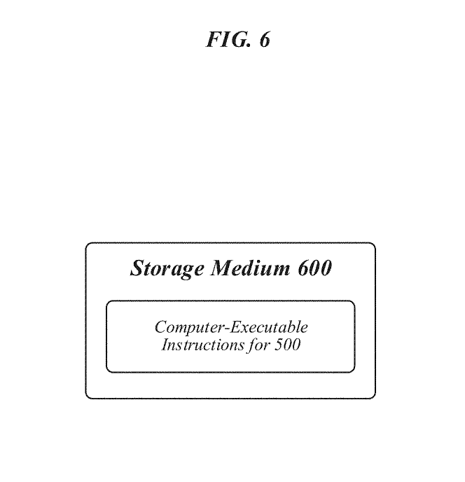

FIG. 6 illustrates an embodiment of a storage medium 600. Storage medium 600 may comprise any non-transitory computer-readable storage medium or machine-readable storage medium, such as an optical, magnetic or semiconductor storage medium. In various embodiments, storage medium 600 may comprise an article of manufacture. In some embodiments, storage medium 600 may store computer-executable instructions, such as computer-executable instructions to implement logic flow 500 of FIG. 5. Examples of a computer-readable storage medium or machine-readable storage medium may include any tangible media capable of storing electronic data, including volatile memory or non-volatile memory, removable or non-removable memory, erasable or non-erasable memory, writeable or re-writeable memory, and so forth. Examples of computer-executable instructions may include any suitable type of code, such as source code, compiled code, interpreted code, executable code, static code, dynamic code, object-oriented code, visual code, and the like. The embodiments are not limited in this context.

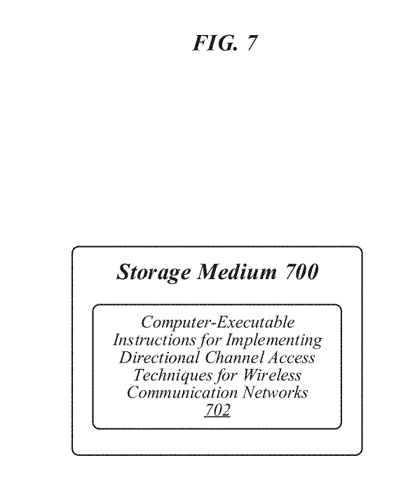

FIG. 7 illustrates an embodiment of a storage medium 700. Storage medium 700 may comprise any non-transitory computer-readable storage medium or machine-readable storage medium, such as an optical, magnetic or semiconductor storage medium. In various embodiments, storage medium 700 may comprise an article of manufacture. In some embodiments, storage medium 700 may store computer-executable instructions, such as computer-executable instructions 702 to implement one or more of the disclosed directional channel access techniques for wireless communication networks. Examples of a computer-readable storage medium or machine-readable storage medium and of computer-executable instructions may include any of the respective examples mentioned above in reference to storage medium 600 of FIG. 6. The embodiments are not limited in this context.

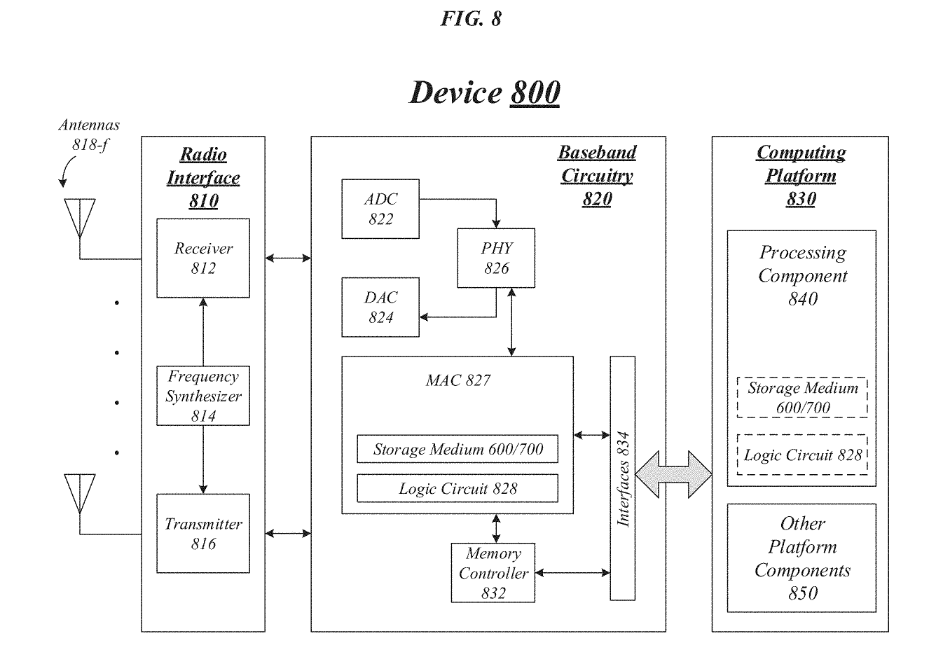

FIG. 8 illustrates an embodiment of a communications device 800 that may implement one or more of wireless communication device 102, logic flow 500, storage medium 600, and storage medium 700. In various embodiments, device 800 may comprise a logic circuit 828. The logic circuit 828 may include physical circuits to perform operations described for one or both of wireless communication device 102 and logic flow 500, for example. As shown in FIG. 8, device 800 may include a radio interface 810, baseband circuitry 820, and computing platform 830, although the embodiments are not limited to this configuration.

The device 800 may implement some or all of the structure and/or operations for one or more of wireless communication device 102, logic flow 500, storage medium 600, storage medium 700, and logic circuit 828 in a single computing entity, such as entirely within a single device. Alternatively, the device 800 may distribute portions of the structure and/or operations for one or more of wireless communication device 102, logic flow 500, storage medium 600, storage medium 700, and logic circuit 828 across multiple computing entities using a distributed system architecture, such as a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

In one embodiment, radio interface 810 may include a component or combination of components adapted for transmitting and/or receiving single-carrier or multi-carrier modulated signals (e.g., including complementary code keying (CCK), orthogonal frequency division multiplexing (OFDM), and/or single-carrier frequency division multiple access (SC-FDMA) symbols) although the embodiments are not limited to any specific over-the-air interface or modulation scheme. Radio interface 810 may include, for example, a receiver 812, a frequency synthesizer 814, and/or a transmitter 816. Radio interface 810 may include bias controls, a crystal oscillator and/or one or more antennas 818-f. In another embodiment, radio interface 810 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 820 may communicate with radio interface 810 to process receive and/or transmit signals and may include, for example, an analog-to-digital converter 822 for down converting received signals, a digital-to-analog converter 824 for up converting signals for transmission. Further, baseband circuitry 820 may include a baseband or physical layer (PHY) processing circuit 826 for PHY link layer processing of respective receive/transmit signals. Baseband circuitry 820 may include, for example, a medium access control (MAC) processing circuit 827 for MAC/data link layer processing. Baseband circuitry 820 may include a memory controller 832 for communicating with MAC processing circuit 827 and/or a computing platform 830, for example, via one or more interfaces 834.

In some embodiments, PHY processing circuit 826 may include a frame construction and/or detection module, in combination with additional circuitry such as a buffer memory, to construct and/or deconstruct communication frames. Alternatively or in addition, MAC processing circuit 827 may share processing for certain of these functions or perform these processes independent of PHY processing circuit 826. In some embodiments, MAC and PHY processing may be integrated into a single circuit.

The computing platform 830 may provide computing functionality for the device 800. As shown, the computing platform 830 may include a processing component 840. In addition to, or alternatively of, the baseband circuitry 820, the device 800 may execute processing operations or logic for one or more of wireless communication device 102, logic flow 500, storage medium 600, storage medium 700, and logic circuit 828 using the processing component 840. The processing component 840 (and/or PHY 826 and/or MAC 827) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing platform 830 may further include other platform components 850. Other platform components 850 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Device 800 may be, for example, an ultra-mobile device, a mobile device, a fixed device, a machine-to-machine (M2M) device, a personal digital assistant (PDA), a mobile computing device, a smart phone, a telephone, a digital telephone, a cellular telephone, user equipment, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, display, television, digital television, set top box, wireless access point, base station, node B, subscriber station, mobile subscriber center, radio network controller, router, hub, gateway, bridge, switch, machine, or combination thereof. Accordingly, functions and/or specific configurations of device 800 described herein, may be included or omitted in various embodiments of device 800, as suitably desired.

Embodiments of device 800 may be implemented using single input single output (SISO) architectures. However, certain implementations may include multiple antennas (e.g., antennas 818-f) for transmission and/or reception using adaptive antenna techniques for beamforming or spatial division multiple access (SDMA) and/or using MIMO communication techniques.

The components and features of device 800 may be implemented using any combination of discrete circuitry, application specific integrated circuits (ASICs), logic gates and/or single chip architectures. Further, the features of device 800 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 800 shown in the block diagram of FIG. 8 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

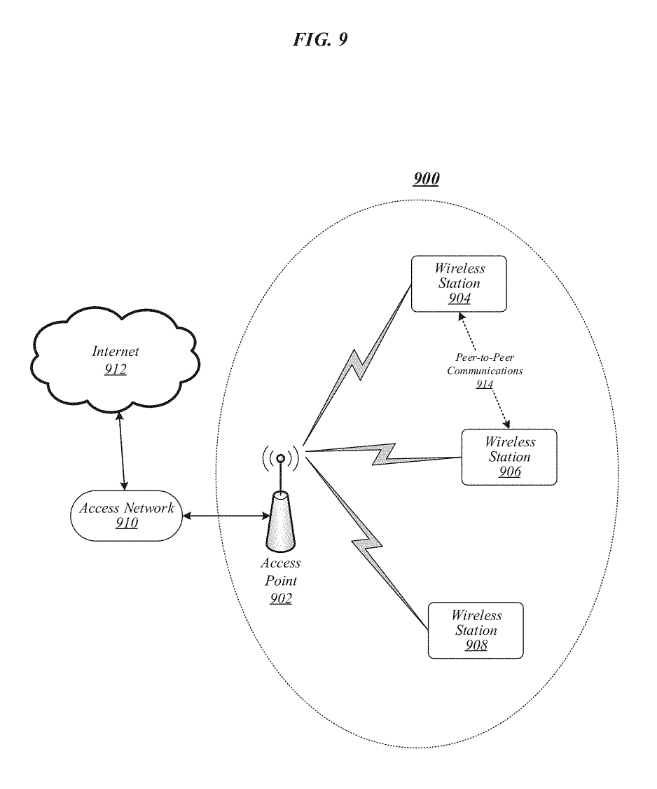

FIG. 9 illustrates an embodiment of a wireless network 900. As shown in FIG. 9, wireless network comprises an access point 902 and wireless stations 904, 906, and 908. In various embodiments, wireless network 900 may comprise a wireless local area network (WLAN), such as a WLAN implementing one or more Institute of Electrical and Electronics Engineers (IEEE) 802.11 standards (sometimes collectively referred to as “Wi-Fi”). In some other embodiments, wireless network 900 may comprise another type of wireless network, and/or may implement other wireless communications standards. In various embodiments, for example, wireless network 900 may comprise a WWAN or WPAN rather than a WLAN. The embodiments are not limited to this example.

In some embodiments, wireless network 900 may implement one or more broadband wireless communications standards, such as 3G or 4G standards, including their revisions, progeny, and variants. Examples of 3G or 4G wireless standards may include without limitation any of the IEEE 802.16m and 802.16p standards, 3rd Generation Partnership Project (3GPP) Long Term Evolution (LTE) and LTE-Advanced (LTE-A) standards, and International Mobile Telecommunications Advanced (IMT-ADV) standards, including their revisions, progeny and variants. Other suitable examples may include, without limitation, Global System for Mobile Communications (GSM)/Enhanced Data Rates for GSM Evolution (EDGE) technologies, Universal Mobile Telecommunications System (UMTS)/High Speed Packet Access (HSPA) technologies, Worldwide Interoperability for Microwave Access (WiMAX) or the WiMAX II technologies, Code Division Multiple Access (CDMA) 2000 system technologies (e.g., CDMA2000 1×RTT, CDMA2000 EV-DO, CDMA EV-DV, and so forth), High Performance Radio Metropolitan Area Network (HIPERMAN) technologies as defined by the European Telecommunications Standards Institute (ETSI) Broadband Radio Access Networks (BRAN), Wireless Broadband (WiBro) technologies, GSM with General Packet Radio Service (GPRS) system (GSM/GPRS) technologies, High Speed Downlink Packet Access (HSDPA) technologies, High Speed Orthogonal Frequency-Division Multiplexing (OFDM) Packet Access (HSOPA) technologies, High-Speed Uplink Packet Access (HSUPA) system technologies, 3GPP Rel. 8-12 of LTE/System Architecture Evolution (SAE), and so forth. The embodiments are not limited in this context.

In various embodiments, wireless stations 904, 906, and 908 may communicate with access point 902 in order to obtain connectivity to one or more external data networks. In some embodiments, for example, wireless stations 904, 906, and 908 may connect to the Internet 912 via access point 902 and access network 910. In various embodiments, access network 910 may comprise a private network that provides subscription-based Internet-connectivity, such as an Internet Service Provider (ISP) network. The embodiments are not limited to this example.

In various embodiments, two or more of wireless stations 904, 906, and 908 may communicate with each other directly by exchanging peer-to-peer communications. For example, in the example of FIG. 9, wireless stations 904 and 906 communicate with each other directly by exchanging peer-to-peer communications 914. In some embodiments, such peer-to-peer communications may be performed according to one or more Wi-Fi Alliance (WFA) standards. For example, in various embodiments, such peer-to-peer communications may be performed according to the WFA Wi-Fi Direct standard, 2010 Release. In various embodiments, such peer-to-peer communications may additionally or alternatively be performed using one or more interfaces, protocols, and/or standards developed by the WFA Wi-Fi Direct Services (WFDS) Task Group. The embodiments are not limited to these examples.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The following examples pertain to further embodiments:

Example 1 is an apparatus, comprising a memory, and logic, at least a portion of which is implemented in circuitry coupled to the memory, the logic to determine an access category (AC) for a medium access control service data unit (MSDU) to be transmitted from a source device to a destination station (STA), store the MSDU in a destination-and-AC-specific (DACS) transmit queue associated with the AC and the destination STA, identify, among a plurality of antennas of the source device, an antenna to be used to transmit the MSDU to the destination STA, and assign the MSDU to an antenna-and-AC specific (AACS) transmit queue associated with the AC and the antenna.

Example 2 is the apparatus of Example 1, the logic to assign the MSDU to a destination-specific sub-queue of the AACS transmit queue, the destination-specific sub-queue to comprise a sub-queue associated with the destination STA.

Example 3 is the apparatus of any of Examples 1 to 2, the antenna to comprise an antenna to be used for single-input single-output (SISO) transmissions from the source device to the destination STA.

Example 4 is the apparatus of Example 3, the antenna to correspond to a best transmit (TX) sector for transmissions to the destination STA.

Example 5 is the apparatus of Example 4, the best TX sector to be identified using a beamforming procedure.

Example 6 is the apparatus of any of Examples 1 to 2, the antenna to comprise one of multiple antennas to be used for multiple-input multiple-output (MIMO) transmissions from the source device to the destination STA.

Example 7 is the apparatus of Example 6, the multiple antennas to be identified using a beamforming procedure.

Example 8 is the apparatus of any of Examples 6 to 7, the logic to assign the MSDU to multiple AACS transmit queues, each one of the multiple AACS transmit queues associated with the AC and a respective one of the multiple antennas.

Example 9 is the apparatus of Example 8, the logic to assign the MSDU to multiple destination-specific sub-queues associated with the destination STA, each one of the multiple destination-specific sub-queues to comprise a sub-queue of a respective one of the multiple AACS transmit queues.

Example 10 is the apparatus of any of Examples 1 to 9, the logic to identify a user priority (UP) associated with the MSDU, and determine the AC for the MSDU based on the identified UP.

Example 11 is the apparatus of any of Examples 1 to 10, the logic to identify one of multiple defined access categories as the AC for the MSDU.

Example 12 is the apparatus of Example 11, the logic to maintain multiple backoff timers for the antenna, each one of the multiple backoff timers to comprise a backoff timer associated with a respective one of the multiple defined access categories.

Example 13 is the apparatus of Example 12, the logic to suspend each of the multiple backoff timers when a clear channel assessment (CCA) of the antenna indicates a busy status.

Example 14 is the apparatus of any of Examples 12 to 13, the logic to decrease each of the multiple backoff timers when a clear channel assessment (CCA) of the antenna indicates a clear status.

Example 15 is the apparatus of any of Examples 12 to 14, the logic to cause transmission of the MSDU using the antenna based at least in part on a determination that a backoff timer associated with the AC has reached zero.

Example 16 is the apparatus of any of Examples 11 to 15, the multiple defined access categories to include a voice (VO) access category, a video (VI) access category, a best effort (BE) access category, and a background (BK) access category.

Example 17 is the apparatus of any of Examples 1 to 16, the AC to comprise a voice (VO) access category.

Example 18 is the apparatus of any of Examples 1 to 16, the AC to comprise a video (VI) access category.

Example 19 is the apparatus of any of Examples 1 to 16, the AC to comprise a best effort (BE) access category.

Example 20 is the apparatus of any of Examples 1 to 16, the AC to comprise a background (BK) access category

Example 21 is the apparatus of any of Examples 1 to 20, the destination STA to comprise a directional multi-gigabit (DMG) STA.

Example 22 is the apparatus of any of Examples 1 to 21, the source device to comprise a directional multi-gigabit (DMG) STA.

Example 23 is the apparatus of any of Examples 1 to 22, the source device to comprise an access point (AP).

Example 24 is the apparatus of any of Examples 1 to 23, the source device to comprise a personal basic service set (PBSS) control point/access point (PCP/AP).

Example 25 is the apparatus of any of Examples 1 to 24, the plurality of antennas to comprise directional multi-gigabit (DMG) antennas.

Example 26 is the apparatus of any of Examples 1 to 25, the antenna to be used to transmit the MSDU to the destination STA over a wireless channel of a 60 GHz frequency band.

Example 27 is a system, comprising an apparatus according to any of Examples 1 to 26, and at least one radio frequency (RF) transceiver.

Example 28 is the system of Example 27, comprising at least one processor.

Example 29 is the system of any of Examples 27 to 28, comprising at least one RF antenna.

Example 30 is at least one non-transitory computer-readable storage medium comprising a set of instructions that, in response to being executed at a wireless communication device, cause the wireless communication device to determine an access category (AC) for a medium access control service data unit (MSDU) to be transmitted to a destination station (STA), store the MSDU in a destination-and-AC-specific (DACS) transmit queue associated with the AC and the destination STA, identify, among a plurality of antennas of the wireless communication device, an antenna to be used to transmit the MSDU to the destination STA, and assign the MSDU to an antenna-and-AC specific (AACS) transmit queue associated with the AC and the antenna.

Example 31 is the at least one non-transitory computer-readable storage medium of Example 30, comprising instructions that, in response to being executed at the wireless communication device, cause the wireless communication device to assign the MSDU to a destination-specific sub-queue of the AACS transmit queue, the destination-specific sub-queue to comprise a sub-queue associated with the destination STA.

Example 32 is the at least one non-transitory computer-readable storage medium of any of Examples 30 to 31, the antenna to comprise an antenna to be used for single-input single-output (SISO) transmissions to the destination STA.

Example 33 is the at least one non-transitory computer-readable storage medium of Example 32, the antenna to correspond to a best transmit (TX) sector for transmissions to the destination STA.

Example 34 is the at least one non-transitory computer-readable storage medium of Example 33, the best TX sector to be identified using a beamforming procedure.

Example 35 is the at least one non-transitory computer-readable storage medium of any of Examples 30 to 31, the antenna to comprise one of multiple antennas to be used for multiple-input multiple-output (MIMO) transmissions to the destination STA.

Example 36 is the at least one non-transitory computer-readable storage medium of Example 35, the multiple antennas to be identified using a beamforming procedure.

Example 37 is the at least one non-transitory computer-readable storage medium of any of Examples 35 to 36, comprising instructions that, in response to being executed at the wireless communication device, cause the wireless communication device to assign the MSDU to multiple AACS transmit queues, each one of the multiple AACS transmit queues associated with the AC and a respective one of the multiple antennas.

Example 38 is the at least one non-transitory computer-readable storage medium of Example 37, comprising instructions that, in response to being executed at the wireless communication device, cause the wireless communication device to assign the MSDU to multiple destination-specific sub-queues associated with the destination STA, each one of the multiple destination-specific sub-queues to comprise a sub-queue of a respective one of the multiple AACS transmit queues.

Example 39 is the at least one non-transitory computer-readable storage medium of any of Examples 30 to 38, comprising instructions that, in response to being executed at the wireless communication device, cause the wireless communication device to identify a user priority (UP) associated with the MSDU, and determine the AC for the MSDU based on the identified UP.

Example 40 is the at least one non-transitory computer-readable storage medium of any of Examples 30 to 39, comprising instructions that, in response to being executed at the wireless communication device, cause the wireless communication device to identify one of multiple defined access categories as the AC for the MSDU.

Example 41 is the at least one non-transitory computer-readable storage medium of Example 40, comprising instructions that, in response to being executed at the wireless communication device, cause the wireless communication device to maintain multiple backoff timers for the antenna, each one of the multiple backoff timers to comprise a backoff timer associated with a respective one of the multiple defined access categories.

Example 42 is the at least one non-transitory computer-readable storage medium of Example 41, comprising instructions that, in response to being executed at the wireless communication device, cause the wireless communication device to suspend each of the multiple backoff timers when a clear channel assessment (CCA) of the antenna indicates a busy status.

Example 43 is the at least one non-transitory computer-readable storage medium of any of Examples 41 to 42, comprising instructions that, in response to being executed at the wireless communication device, cause the wireless communication device to decrease each of the multiple backoff timers when a clear channel assessment (CCA) of the antenna indicates a clear status.

Example 44 is the at least one non-transitory computer-readable storage medium of any of Examples 41 to 43, comprising instructions that, in response to being executed at the wireless communication device, cause the wireless communication device to cause transmission of the MSDU using the antenna based at least in part on a determination that a backoff timer associated with the AC has reached zero.

Example 45 is the at least one non-transitory computer-readable storage medium of any of Examples 40 to 44, the multiple defined access categories to include a voice (VO) access category, a video (VI) access category, a best effort (BE) access category, and a background (BK) access category.

Example 46 is the at least one non-transitory computer-readable storage medium of any of Examples 30 to 45, the AC to comprise a voice (VO) access category.

Example 47 is the at least one non-transitory computer-readable storage medium of any of Examples 30 to 45, the AC to comprise a video (VI) access category.

Example 48 is the at least one non-transitory computer-readable storage medium of any of Examples 30 to 45, the AC to comprise a best effort (BE) access category.

Example 49 is the at least one non-transitory computer-readable storage medium of any of Examples 30 to 45, the AC to comprise a background (BK) access category

Example 50 is the at least one non-transitory computer-readable storage medium of any of Examples 30 to 49, the destination STA to comprise a directional multi-gigabit (DMG) STA.

Example 51 is the at least one non-transitory computer-readable storage medium of any of Examples 30 to 50, the wireless communication device to comprise a directional multi-gigabit (DMG) STA.

Example 52 is the at least one non-transitory computer-readable storage medium of any of Examples 30 to 51, the wireless communication device to comprise an access point (AP).

Example 53 is the at least one non-transitory computer-readable storage medium of any of Examples 30 to 52, the wireless communication device to comprise a personal basic service set (PBSS) control point/access point (PCP/AP).

Example 54 is the at least one non-transitory computer-readable storage medium of any of Examples 30 to 53, the plurality of antennas to comprise directional multi-gigabit (DMG) antennas.

Example 55 is the at least one non-transitory computer-readable storage medium of any of Examples 30 to 54, the antenna to be used to transmit the MSDU to the destination STA over a wireless channel of a 60 GHz frequency band.

Example 56 is a method, comprising determining, by circuitry of a wireless communication device, an access category (AC) for a medium access control service data unit (MSDU) to be transmitted to a destination station (STA), storing the MSDU in a destination-and-AC-specific (DACS) transmit queue associated with the AC and the destination STA, identifying, among a plurality of antennas of the wireless communication device, an antenna to be used to transmit the MSDU to the destination STA, and assigning the MSDU to an antenna-and-AC specific (AACS) transmit queue associated with the AC and the antenna.

Example 57 is the method of Example 56, comprising assigning the MSDU to a destination-specific sub-queue of the AACS transmit queue, the destination-specific sub-queue to comprise a sub-queue associated with the destination STA.

Example 58 is the method of any of Examples 56 to 57, the antenna to comprise an antenna to be used for single-input single-output (SISO) transmissions to the destination STA.

Example 59 is the method of Example 58, the antenna to correspond to a best transmit (TX) sector for transmissions to the destination STA.

Example 60 is the method of Example 59, the best TX sector to be identified using a beamforming procedure.

Example 61 is the method of any of Examples 56 to 57, the antenna to comprise one of multiple antennas to be used for multiple-input multiple-output (MIMO) transmissions to the destination STA.

Example 62 is the method of Example 61, the multiple antennas to be identified using a beamforming procedure.

Example 63 is the method of any of Examples 61 to 62, comprising assigning the MSDU to multiple AACS transmit queues, each one of the multiple AACS transmit queues associated with the AC and a respective one of the multiple antennas.

Example 64 is the method of Example 63, comprising assigning the MSDU to multiple destination-specific sub-queues associated with the destination STA, each one of the multiple destination-specific sub-queues to comprise a sub-queue of a respective one of the multiple AACS transmit queues.

Example 65 is the method of any of Examples 56 to 64, comprising identifying a user priority (UP) associated with the MSDU, and determining the AC for the MSDU based on the identified UP.

Example 66 is the method of any of Examples 56 to 65, comprising identifying one of multiple defined access categories as the AC for the MSDU.

Example 67 is the method of Example 66, comprising maintaining multiple backoff timers for the antenna, each one of the multiple backoff timers to comprise a backoff timer associated with a respective one of the multiple defined access categories.

Example 68 is the method of Example 67, comprising suspending each of the multiple backoff timers when a clear channel assessment (CCA) of the antenna indicates a busy status.

Example 69 is the method of any of Examples 67 to 68, comprising decreasing each of the multiple backoff timers when a clear channel assessment (CCA) of the antenna indicates a clear status.

Example 70 is the method of any of Examples 67 to 69, comprising causing transmission of the MSDU using the antenna based at least in part on a determination that a backoff timer associated with the AC has reached zero.

Example 71 is the method of any of Examples 66 to 70, the multiple defined access categories to include a voice (VO) access category, a video (VI) access category, a best effort (BE) access category, and a background (BK) access category.

Example 72 is the method of any of Examples 56 to 71, the AC to comprise a voice (VO) access category.

Example 73 is the method of any of Examples 56 to 71, the AC to comprise a video (VI) access category.

Example 74 is the method of any of Examples 56 to 71, the AC to comprise a best effort (BE) access category.

Example 75 is the method of any of Examples 56 to 71, the AC to comprise a background (BK) access category

Example 76 is the method of any of Examples 56 to 75, the destination STA to comprise a directional multi-gigabit (DMG) STA.

Example 77 is the method of any of Examples 56 to 76, the wireless communication device to comprise a directional multi-gigabit (DMG) STA.

Example 78 is the method of any of Examples 56 to 77, the wireless communication device to comprise an access point (AP).

Example 79 is the method of any of Examples 56 to 78, the wireless communication device to comprise a personal basic service set (PBSS) control point/access point (PCP/AP).

Example 80 is the method of any of Examples 56 to 79, the plurality of antennas to comprise directional multi-gigabit (DMG) antennas.

Example 81 is the method of any of Examples 56 to 80, the antenna to be used to transmit the MSDU to the destination STA over a wireless channel of a 60 GHz frequency band.

Example 82 is at least one non-transitory computer-readable storage medium comprising a set of instructions that, in response to being executed on a computing device, cause the computing device to perform a method according to any of Examples 56 to 81.

Example 83 is an apparatus, comprising means for performing a method according to any of Examples 56 to 81.

Example 84 is a system, comprising the apparatus of Example 83, and at least one radio frequency (RF) transceiver.

Example 85 is the system of Example 84, comprising at least one RF antenna.

Example 86 is the system of any of Examples 84 to 85, comprising at least one processor.

Example 87 is a apparatus, comprising means for determining an access category (AC) for a medium access control service data unit (MSDU) to be transmitted from a wireless communication device to a destination station (STA), means for storing the MSDU in a destination-and-AC-specific (DACS) transmit queue associated with the AC and the destination STA, means for identifying, among a plurality of antennas of the wireless communication device, an antenna to be used to transmit the MSDU to the destination STA, and means for assigning the MSDU to an antenna-and-AC specific (AACS) transmit queue associated with the AC and the antenna.

Example 88 is the apparatus of Example 87, comprising means for assigning the MSDU to a destination-specific sub-queue of the AACS transmit queue, the destination-specific sub-queue to comprise a sub-queue associated with the destination STA.

Example 89 is the apparatus of any of Examples 87 to 88, the antenna to comprise an antenna to be used for single-input single-output (SISO) transmissions to the destination STA.

Example 90 is the apparatus of Example 89, the antenna to correspond to a best transmit (TX) sector for transmissions to the destination STA.

Example 91 is the apparatus of Example 90, the best TX sector to be identified using a beamforming procedure.

Example 92 is the apparatus of any of Examples 87 to 88, the antenna to comprise one of multiple antennas to be used for multiple-input multiple-output (MIMO) transmissions to the destination STA.

Example 93 is the apparatus of Example 92, the multiple antennas to be identified using a beamforming procedure.

Example 94 is the apparatus of any of Examples 92 to 93, comprising means for assigning the MSDU to multiple AACS transmit queues, each one of the multiple AACS transmit queues associated with the AC and a respective one of the multiple antennas.

Example 95 is the apparatus of Example 94, comprising means for assigning the MSDU to multiple destination-specific sub-queues associated with the destination STA, each one of the multiple destination-specific sub-queues to comprise a sub-queue of a respective one of the multiple AACS transmit queues.

Example 96 is the apparatus of any of Examples 87 to 95, comprising means for identifying a user priority (UP) associated with the MSDU, and determining the AC for the MSDU based on the identified UP.

Example 97 is the apparatus of any of Examples 87 to 96, comprising means for identifying one of multiple defined access categories as the AC for the MSDU.

Example 98 is the apparatus of Example 97, comprising means for maintaining multiple backoff timers for the antenna, each one of the multiple backoff timers to comprise a backoff timer associated with a respective one of the multiple defined access categories.

Example 99 is the apparatus of Example 98, comprising means for suspending each of the multiple backoff timers when a clear channel assessment (CCA) of the antenna indicates a busy status.

Example 100 is the apparatus of any of Examples 98 to 99, comprising means for decreasing each of the multiple backoff timers when a clear channel assessment (CCA) of the antenna indicates a clear status.

Example 101 is the apparatus of any of Examples 98 to 100, comprising means for causing transmission of the MSDU using the antenna based at least in part on a determination that a backoff timer associated with the AC has reached zero.

Example 102 is the apparatus of any of Examples 97 to 101, the multiple defined access categories to include a voice (VO) access category, a video (VI) access category, a best effort (BE) access category, and a background (BK) access category.

Example 103 is the apparatus of any of Examples 87 to 102, the AC to comprise a voice (VO) access category.

Example 104 is the apparatus of any of Examples 87 to 102, the AC to comprise a video (VI) access category.

Example 105 is the apparatus of any of Examples 87 to 102, the AC to comprise a best effort (BE) access category.

Example 106 is the apparatus of any of Examples 87 to 102, the AC to comprise a background (BK) access category

Example 107 is the apparatus of any of Examples 87 to 106, the destination STA to comprise a directional multi-gigabit (DMG) STA.

Example 108 is the apparatus of any of Examples 87 to 107, the wireless communication device to comprise a directional multi-gigabit (DMG) STA.

Example 109 is the apparatus of any of Examples 87 to 108, the wireless communication device to comprise an access point (AP).

Example 110 is the apparatus of any of Examples 87 to 109, the wireless communication device to comprise a personal basic service set (PBSS) control point/access point (PCP/AP).

Example 111 is the apparatus of any of Examples 87 to 110, the plurality of antennas to comprise directional multi-gigabit (DMG) antennas.

Example 112 is the apparatus of any of Examples 87 to 111, the antenna to be used to transmit the MSDU to the destination STA over a wireless channel of a 60 GHz frequency band.

Example 113 is a system, comprising an apparatus according to any of Examples 87 to 112, and at least one radio frequency (RF) transceiver.

Example 114 is the system of Example 113, comprising at least one processor.

Example 115 is the system of any of Examples 113 to 114, comprising at least one RF antenna.

Example 116 is a wireless communication device, comprising a plurality of antennas, a memory, and logic, at least a portion of which is implemented in circuitry coupled to the memory, the logic to determine an access category (AC) for a medium access control service data unit (MSDU) to be transmitted to a destination station (STA), store the MSDU in a destination-and-AC-specific (DACS) transmit queue associated with the AC and the destination STA, identify, among the plurality of antennas, an antenna to be used to transmit the MSDU to the destination STA, and assign the MSDU to an antenna-and-AC specific (AACS) transmit queue associated with the AC and the antenna.

Example 117 is the wireless communication device of Example 116, the logic to assign the MSDU to a destination-specific sub-queue of the AACS transmit queue, the destination-specific sub-queue to comprise a sub-queue associated with the destination STA.

Example 118 is the wireless communication device of any of Examples 116 to 117, the antenna to comprise an antenna to be used for single-input single-output (SISO) transmissions to the destination STA.

Example 119 is the wireless communication device of Example 118, the antenna to correspond to a best transmit (TX) sector for transmissions to the destination STA.

Example 120 is the wireless communication device of Example 119, the best TX sector to be identified using a beamforming procedure.

Example 121 is the wireless communication device of any of Examples 116 to 117, the antenna to comprise one of multiple antennas to be used for multiple-input multiple-output (MIMO) transmissions to the destination STA.

Example 122 is the wireless communication device of Example 121, the multiple antennas to be identified using a beamforming procedure.

Example 123 is the wireless communication device of any of Examples 121 to 122, the logic to assign the MSDU to multiple AACS transmit queues, each one of the multiple AACS transmit queues associated with the AC and a respective one of the multiple antennas.

Example 124 is the wireless communication device of Example 123, the logic to assign the MSDU to multiple destination-specific sub-queues associated with the destination STA, each one of the multiple destination-specific sub-queues to comprise a sub-queue of a respective one of the multiple AACS transmit queues.

Example 125 is the wireless communication device of any of Examples 116 to 124, the logic to identify a user priority (UP) associated with the MSDU, and determine the AC for the MSDU based on the identified UP.

Example 126 is the wireless communication device of any of Examples 116 to 125, the logic to identify one of multiple defined access categories as the AC for the MSDU.

Example 127 is the wireless communication device of Example 126, the logic to maintain multiple backoff timers for the antenna, each one of the multiple backoff timers to comprise a backoff timer associated with a respective one of the multiple defined access categories.

Example 128 is the wireless communication device of Example 127, the logic to suspend each of the multiple backoff timers when a clear channel assessment (CCA) of the antenna indicates a busy status.

Example 129 is the wireless communication device of any of Examples 127 to 128, the logic to decrease each of the multiple backoff timers when a clear channel assessment (CCA) of the antenna indicates a clear status.

Example 130 is the wireless communication device of any of Examples 127 to 129, the logic to cause transmission of the MSDU using the antenna based at least in part on a determination that a backoff timer associated with the AC has reached zero.

Example 131 is the wireless communication device of any of Examples 126 to 130, the multiple defined access categories to include a voice (VO) access category, a video (VI) access category, a best effort (BE) access category, and a background (BK) access category.

Example 132 is the wireless communication device of any of Examples 116 to 131, the AC to comprise a voice (VO) access category.

Example 133 is the wireless communication device of any of Examples 116 to 131, the AC to comprise a video (VI) access category.

Example 134 is the wireless communication device of any of Examples 116 to 131, the AC to comprise a best effort (BE) access category.

Example 135 is the wireless communication device of any of Examples 116 to 131, the AC to comprise a background (BK) access category

Example 136 is the wireless communication device of any of Examples 116 to 135, the destination STA to comprise a directional multi-gigabit (DMG) STA.

Example 137 is the wireless communication device of any of Examples 116 to 136, the plurality of antennas to comprise directional multi-gigabit (DMG) antennas.

Example 138 is the wireless communication device of any of Examples 116 to 137, the antenna to be used to transmit the MSDU to the destination STA over a wireless channel of a 60 GHz frequency band.

Numerous specific details have been set forth herein to provide a thorough understanding of the embodiments. It will be understood by those skilled in the art, however, that the embodiments may be practiced without these specific details. In other instances, well-known operations, components, and circuits have not been described in detail so as not to obscure the embodiments. It can be appreciated that the specific structural and functional details disclosed herein may be representative and do not necessarily limit the scope of the embodiments.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus, comprising:
a memory; and
logic, at least a portion of which is implemented in circuitry coupled to the memory, the logic to:
determine an access category (AC) for a medium access control service data unit (MSDU) to be transmitted from a source device to a destination station (STA);
store the MSDU in a destination-and-AC-specific (DACS) transmit queue associated with the AC and the destination STA;
identify, among a plurality of antennas of the source device, an antenna to be used to transmit the MSDU to the destination STA; and
assign the MSDU to an antenna-and-AC specific (AACS) transmit queue associated with the AC and the antenna.

2. The apparatus of claim 1, the logic to assign the MSDU to a destination-specific sub-queue of the AACS transmit queue, the destination-specific sub-queue to comprise a sub-queue associated with the destination STA.

3. The apparatus of claim 1, the antenna to correspond to a best transmit (TX) sector for single-input single-output (SISO) transmissions from the source device to the destination STA.

4. The apparatus of claim 1, the antenna to comprise one of multiple antennas to be used for multiple-input multiple-output (MIMO) transmissions from the source device to the destination STA, the logic to assign the MSDU to multiple AACS transmit queues, each one of the multiple AACS transmit queues associated with the AC and a respective one of the multiple antennas.

5. The apparatus of claim 4, the logic to assign the MSDU to multiple destination-specific sub-queues associated with the destination STA, each one of the multiple destination-specific sub-queues to comprise a sub-queue of a respective one of the multiple AACS transmit queues.

6. The apparatus of claim 1, the logic to:
identify a user priority (UP) associated with the MSDU; and
determine the AC for the MSDU based on the identified UP.

7. The apparatus of claim 1, the AC to comprise one of a voice (VO) access category, a video (VI) access category, a best effort (BE) access category, and a background (BK) access category.

8. The apparatus of claim 7, the logic to maintain multiple backoff timers for the antenna, the multiple backoff timers to include a backoff timer associated with the VO access category, a backoff timer associated with the VI access category, a backoff timer associated with the BE access category, and a backoff timer associated with the BK access category.

9. A system, comprising:
the apparatus of claim 1;
at least one radio frequency (RF) transceiver; and
at least one RF antenna.

10. At least one non-transitory computer-readable storage medium comprising a set of instructions that, in response to being executed at a wireless communication device, cause the wireless communication device to:
determine an access category (AC) for a medium access control service data unit (MSDU) to be transmitted to a destination station (STA);
store the MSDU in a destination-and-AC-specific (DACS) transmit queue associated with the AC and the destination STA;
identify, among a plurality of antennas of the wireless communication device, an antenna to be used to transmit the MSDU to the destination STA; and
assign the MSDU to an antenna-and-AC specific (AACS) transmit queue associated with the AC and the antenna.

11. The at least one non-transitory computer-readable storage medium of claim 10, comprising instructions that, in response to being executed at the wireless communication device, cause the wireless communication device to assign the MSDU to a destination-specific sub-queue of the AACS transmit queue, the destination-specific sub-queue to comprise a sub-queue associated with the destination STA.

12. The at least one non-transitory computer-readable storage medium of claim 10, the antenna to correspond to a best transmit (TX) sector for single-input single-output (SISO) transmissions from the wireless communication device to the destination STA.

13. The at least one non-transitory computer-readable storage medium of claim 10, the antenna to comprise one of multiple antennas to be used for multiple-input multiple-output (MIMO) transmissions from the wireless communication device to the destination STA, the logic to assign the MSDU to multiple AACS transmit queues, each one of the multiple AACS transmit queues associated with the AC and a respective one of the multiple antennas.

14. The at least one non-transitory computer-readable storage medium of claim 13, comprising instructions that, in response to being executed at the wireless communication device, cause the wireless communication device to assign the MSDU to multiple destination-specific sub-queues associated with the destination STA, each one of the multiple destination-specific sub-queues to comprise a sub-queue of a respective one of the multiple AACS transmit queues.

15. The at least one non-transitory computer-readable storage medium of claim 10, comprising instructions that, in response to being executed at the wireless communication device, cause the wireless communication device to:
identify a user priority (UP) associated with the MSDU; and
determine the AC for the MSDU based on the identified UP.

16. The at least one non-transitory computer-readable storage medium of claim 10, the AC to comprise one of a voice (VO) access category, a video (VI) access category, a best effort (BE) access category, and a background (BK) access category.

17. The at least one non-transitory computer-readable storage medium of claim 16, comprising instructions that, in response to being executed at the wireless communication device, cause the wireless communication device to maintain multiple backoff timers for the antenna, the multiple backoff timers to include a backoff timer associated with the VO access category, a backoff timer associated with the VI access category, a backoff timer associated with the BE access category, and a backoff timer associated with the BK access category.

18. A wireless communication device, comprising:
a plurality of antennas;
a memory; and
logic, at least a portion of which is implemented in circuitry coupled to the memory, the logic to:
determine an access category (AC) for a medium access control service data unit (MSDU) to be transmitted to a destination station (STA);
store the MSDU in a destination-and-AC-specific (DACS) transmit queue associated with the AC and the destination STA;
identify, among the plurality of antennas, an antenna to be used to transmit the MSDU to the destination STA; and
assign the MSDU to an antenna-and-AC specific (AACS) transmit queue associated with the AC and the antenna.

19. The wireless communication device of claim 18, the logic to assign the MSDU to a destination-specific sub-queue of the AACS transmit queue, the destination-specific sub-queue to comprise a sub-queue associated with the destination STA.

20. The wireless communication device of claim 18, the antenna to correspond to a best transmit (TX) sector for single-input single-output (SISO) transmissions to the destination STA.

21. The wireless communication device of claim 18, the antenna to comprise one of multiple antennas to be used for multiple-input multiple-output (MIMO) transmissions to the destination STA, the logic to assign the MSDU to multiple AACS transmit queues, each one of the multiple AACS transmit queues associated with the AC and a respective one of the multiple antennas.

22. The wireless communication device of claim 21, the logic to assign the MSDU to multiple destination-specific sub-queues associated with the destination STA, each one of the multiple destination-specific sub-queues to comprise a sub-queue of a respective one of the multiple AACS transmit queues.

23. The wireless communication device of claim 18, the logic to:
identify a user priority (UP) associated with the MSDU; and
determine the AC for the MSDU based on the identified UP.

24. The wireless communication device of claim 18, the AC to comprise one of a voice (VO) access category, a video (VI) access category, a best effort (BE) access category, and a background (BK) access category.

25. The wireless communication device of claim 24, the logic to maintain multiple backoff timers for the antenna, the multiple backoff timers to include a backoff timer associated with the VO access category, a backoff timer associated with the VI access category, a backoff timer associated with the BE access category, and a backoff timer associated with the BK access category.
